(19) United States
(12) Patent Application Publication
(10) Pub. No.: US 2017/0069317 A1
(43) Pub. Date: Mar. 9, 2017

(54) VOICE RECOGNITION APPARATUS, DRIVING METHOD THEREOF, AND NON-TRANSITORY COMPUTER-READABLE RECORDING MEDIUM

(71) Applicant: SAMSUNG ELECTRONICS CO., LTD., Suwon-si (KR)

(72) Inventor: Nam-yeong KWON, Suwon-si (KR)

(73) Assignee: SAMSUNG ELECTRONICS CO., LTD., Suwon-si (KR)

(21) Appl. No.: 15/197,015

(22) Filed: Jun. 29, 2016

(30) Foreign Application Priority Data
Sep. 4, 2015 (KR) 10-2015-0125467

(51) Int. Cl. G10L 15/20; G06F 3/16; G10L 17/04; G10L 15/28

(52) U.S. Cl. CPC G10L 15/20; G10L 15/285; G06F 3/167; G10L 17/04; G10L 2015/223

(57) ABSTRACT

A voice recognition apparatus includes a voice recognition processor configured to determine whether or not a voice command included in log data related to operation execution of an apparatus is a normal recognition utterance intentionally uttered by a user by analyzing the log data, and build a DB with respect to a recognition result of the voice command determined as the normal recognition utterance as a determination result.

### CROSS-REFERENCE TO RELATED APPLICATION

This application claims priority from Korean Patent Application No. 10-2015-0125467, filed on Sep. 4, 2015, in the Korean Intellectual Property Office, the disclosure of which is incorporated herein by reference in its entirety.

### BACKGROUND

Field

Apparatuses and methods consistent with exemplary embodiments relate to a voice recognition apparatus, a driving method thereof, and a non-transitory computer-readable recording medium, and more particularly, to a voice recognition apparatus capable of preventing unexpected various misrecognitions by reflecting various conditions occurrable in an actual environment in response to a specific operation through voice recognition being performed in an image display apparatus such as a digital television (DTV), a driving method thereof, and a non-transitory computer-readable recording medium.

Description of the Related Art

Due to the increase in the voice recognition providing apparatuses and services, the voice recognition have been used in various forms in various places. As the voice recognition is used in various environments and devices, the voice recognition technology has been researched by focusing on satisfying the recognition performance of the voice recognition, that is, the recognition rate. The recognition performance has been improved without the inconvenience for practical use as the technology is advanced. However, the misrecognition by similar utterance has still occurred since the voice recognition is focused on the recognition performance.

The misrecognition model with respect to a pronunciation similar to a recognition vocabulary may be used to improve the misrecognition performance. However, the misrecognition through the methods such as registration through modulation for misrecognizable pronunciation or a rejection model for a non-voice database (DB), determination of relative importance for rejection vocabularies through partial division, and uniform reflection in building of an actual use model may have a difference from the actual misrecognition caused in using of voice recognition of the user.

Since the rejection for the recognition result is performed through comparison with a result output after current recognition using the existing built DB in verification for the misrecognition, it is difficult to induce the user to effectively use the voice recognition later. Such simple comparison and rejection may instill a very negative view in use of user's voice recognition.

Most of voice recognition in the related art has been focused only on improving the recognition performance. The technology proposed to prevent the misrecognition may also determine whether a corresponding voice is normally recognized or misrecognized using features used in the general voice recognition. The determination method is merely a method for improving the performance of the general voice recognition. Most of the misrecognition caused in the environment that the user actually use the voice recognition may be beyond the common sense range.

Accordingly, it is difficult to effectively prevent the misrecognition in the actual use environments without actual use data for preventing the misrecognition in the environment that the user actually use the voice recognition.

### SUMMARY

Exemplary embodiments may overcome the above disadvantages and other disadvantages not described above. Also, an exemplary embodiment is not required to overcome the disadvantages described above, and an exemplary embodiment may not overcome any of the problems described above.

One or more exemplary embodiments relate to a voice recognition apparatus capable of preventing unexpected various misrecognitions by reflecting various conditions occurrable in an actual environment in response to a specific operation through voice recognition being performed in an image display apparatus such as a DTV, a driving method thereof, and a computer-readable recording medium.

According to an aspect of an exemplary embodiment, there is provided a voice recognition system including an image display apparatus configured to collect log data related to operation execution of an apparatus; and an voice recognition apparatus configured to determine whether or not a voice command included in the log data is a normal recognition utterance intentionally uttered by a user by analyzing the collected log data and build a database (DB) with respect to a recognition result of the voice command determined as the normal recognition utterance as a determination result.

According to an aspect of an exemplary embodiment, there is provided a voice recognition apparatus including a communication interface configured to receive log data related to operation execution of a user apparatus; and a voice recognition processor configured to determine whether or not a voice command included in the log data is a normal recognition utterance intentionally uttered by a user by analyzing the received log data and build a database (DB) with respect to a recognition result of the voice command determined as the normal recognition utterance as a determination result.

The communication interface may transmit a text-based recognition result acquired by analyzing audio data of the voice command to the voice recognition apparatus.

According to an aspect of an exemplary embodiment, there is provided a voice recognition apparatus including a voice recognition processor configured to determine whether or not a voice command included in log data related to operation execution of an apparatus is a normal recognition utterance intentionally uttered by a user by analyzing the log data and build a database (DB) with respect to a recognition result of the voice command determined as the normal recognition utterance as a determination result.

The voice recognition processor may determine whether or not the voice command is included in the log data and determine the normal recognition utterance based on an operation state of the voice recognition apparatus subsequent to the determined voice command.

The voice recognition processor may determine the voice command as the normal recognition utterance in response to another voice command subsequent to the voice command being determined as the operation state.

The voice recognition processor may determine the voice command as a misrecognition utterance unintentionally uttered by a user in response to a user utterance subsequent to the voice command being not presented for a fixed time or power being turned off as the operation state.

The voice recognition processor may temporarily store a recognition result determined as the normal recognition utterance and a recognition result determined as a misrecognition utterance unintentionally uttered by a user and verify whether or not a recognition rate is improved by the temporarily stored recognition results by determining whether or not preset audio experiment data is recognized as the temporarily stored recognition results.

The voice recognition processor may temporarily store a recognition result determined as the normal recognition utterance and a recognition result determined as a misrecognition utterance unintentionally uttered by a user and verify whether or not a recognition rate is improved by the temporarily stored recognition results by determining whether or not the received voice command is recognized as the temporarily stored recognition results after the temporary storing of the recognition results.

The voice recognition processor may build the DB with respect to a recognition result of which the recognition rate is improved as a verifying result.

The voice recognition apparatus may further include a communication interface configured to transmit the log data to the server-based voice recognition apparatus to build the DB with respect to the recognition result in the server-based voice recognition apparatus.

The communication interface may transmit the log data in a text-based recognition result form acquired by analyzing audio data of the voice command.

According to an aspect of an exemplary embodiment, there is provided a method of driving a voice recognition apparatus, the method including receiving log data related to operation execution of a user apparatus; determining whether or not a voice command included in the log data is a normal recognition utterance intentionally uttered by a user by analyzing the received log data; and building a database (DB) with respect to a recognition result of the voice command determined as the normal recognition utterance as a determination result.

The receiving may include receiving the log data in a text-based recognition result form acquired by analyzing audio data of the voice command.

According to an aspect of an exemplary embodiment, there is provided a method of driving a voice recognition apparatus, the method including determining whether or not a voice command included in log data related to operation execution of a user apparatus is a normal recognition utterance intentionally uttered by a user by analyzing the log data; and building a database (DB) with respect to a recognition result of the voice command determined as the normal recognition utterance as a determination result.

The determining may include determining the normal recognition utterance by determining whether or not the voice command is included in the log data and determining an operation state of the user apparatus subsequent to the determined voice command.

The determining may include determining the voice command as the normal recognition utterance in response to another voice command subsequent to the voice command being determined as the operation state.

The determining may include determining the voice command as a misrecognition utterance unintentionally intended by a user in response to a user utterance subsequent to the voice command being not presented for a fixed time or power being turned off as the operation state.

The method may further include storing preset audio experiment data; temporarily storing a recognition result determined as the normal recognition utterance and a recognition result determined as a misrecognition utterance unintentionally uttered by a user; and verifying whether or not a recognition rate is improved by the temporarily stored recognition results by determining whether or not the preset audio experiment data is recognized as the temporarily stored recognition results.

The method may further include temporarily storing a recognition result determined as the normal recognition utterance and a recognition result determined as a misrecognition utterance unintentionally uttered by a user; and verifying whether or not a recognition rate is improved by the temporarily stored recognition results by determining whether or not the received voice command is recognized as the temporarily stored recognition results after the temporary storing of the recognition results.

The building of the DB may include building the DB with respect to a recognition result of which the recognition rate is improved as a verifying result.

The method may further include transmitting the log data to the server-based voice recognition apparatus to build the DB with respect to the recognition result in the server-based voice recognition apparatus.

The transmitting may include transmitting the log data in a text-based recognition result form acquired by analyzing audio data of the voice command.

According to an aspect of an exemplary embodiment, there is provided a computer-readable recording medium including a program for executing a method of driving a voice recognition apparatus, the method including determining whether or not a voice command included in log data related to operation execution of an apparatus is a normal recognition utterance intentionally uttered by a user by analyzing the log data; and building a database (DB) with respect to a recognition result of the voice command determined as the normal recognition utterance as a determination result.

According to an aspect of an exemplary embodiment, there is provided an image display apparatus including a storage unit configured to store log data related to operation execution of an apparatus; and a voice recognition processor configured to determine whether or not a voice command included in the log data is a normal recognition utterance intentionally uttered by a user by analyzing the stored log data and build a database (DB) with respect to a recognition result of the voice command determined as the normal recognition utterance as a determination result.

According to an aspect of an exemplary embodiment, there is provided a method of driving an image display apparatus, the method including storing log data related to operation execution of an apparatus; determining whether or not a voice command included in the log data is a normal recognition utterance intentionally uttered by a user by analyzing the stored log data; and building a database (DB) with respect to a recognition result of the voice command determined as the normal recognition utterance as a determination result.

Additional aspects and advantages of the exemplary embodiments are set forth in the detailed description, and will be obvious from the detailed description, or may be learned by practicing the exemplary embodiments.

### BRIEF DESCRIPTION OF THE DRAWINGS

The above and/or other aspects will become more apparent by describing certain exemplary embodiments with reference to the accompanying drawings, in which:

FIG. 1 is a diagram illustrating a voice recognition system according to an exemplary embodiment;

FIG. 2 is a block diagram illustrating a configuration of an image display apparatus according to a first exemplary embodiment;

FIG. 3 is a block diagram illustrating a configuration of an image display apparatus according to a second exemplary embodiment;

FIG. 4 is a diagram illustrating a configuration of a controller of FIG. 3;

FIG. 5 is a block diagram illustrating a configuration of an image display apparatus according to a third exemplary embodiment;

FIG. 6 is a block diagram illustrating a configuration of a voice recognition apparatus according to a first exemplary embodiment;

FIG. 7 is a block diagram illustrating a configuration of a voice recognition apparatus according to a second exemplary embodiment;

FIG. 8 is a detailed block diagram illustrating a configuration of a voice recognition processor of FIG. 6 or a voice recognition execution processor of FIG. 7;

FIG. 9 is a detailed block diagram illustrating a configuration of a voice recognition unit of FIG. 8;

FIG. 10 is a diagram illustrating a structure of an actual utterance database (DB) of FIG. 8;

FIG. 11 is a detailed block diagram illustrating a configuration of a dictionary building unit of FIG. 10;

FIG. 12 is a diagram illustrating a driving process of an image display apparatus according to an exemplary embodiment;

FIG. 13 is a flowchart illustrating a driving process of a voice recognition apparatus according to a first exemplary embodiment; and

FIG. 14 is a flowchart illustrating a driving method of a voice recognition apparatus according to a second exemplary embodiment.

### DETAILED DESCRIPTION OF EXEMPLARY EMBODIMENTS

Certain exemplary embodiments will be described in greater detail with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

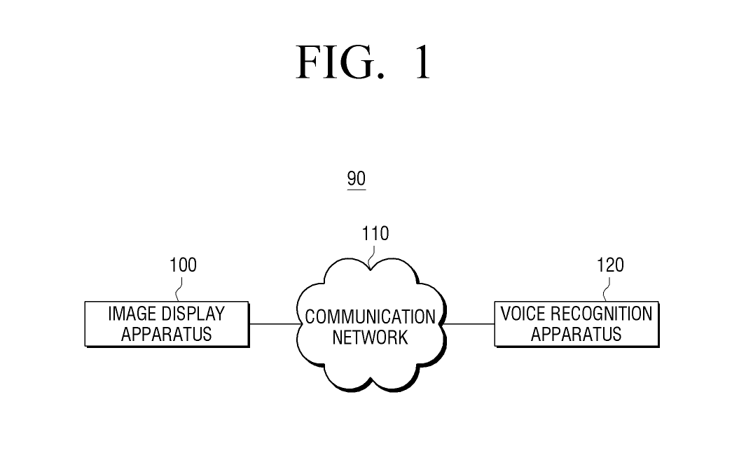

FIG. 1 is a diagram illustrating a voice recognition system according to an exemplary embodiment.

As illustrated in FIG. 1, a voice recognition system 90 according to an exemplary embodiment may include all or a portion of an image display apparatus 100, a communication network 110, and a voice recognition apparatus 120.

The phrase “include all or a part” may mean that the communication network 110 may be omitted in the system in response to direct communication (for example, peer to peer (P2P)) being performed between the image display apparatus 100 and the voice recognition apparatus 120, and the voice recognition apparatus 120 may be omitted in the system in response to a recognition operation being autonomously performed in the image display apparatus 100. For a thorough understanding of the inventive concept, the voice recognition system 90 will be described to include all the components.

The image display apparatus 100 may include an apparatus which may display an image such as a portable phone, a laptop computer, a desktop computer, a tablet personal computer (PC), a portable multimedia player (PDP), an MP3 player, and a TV. Here, the image display apparatus 100 may be one of cloud terminals. For example, in response to a voice command in a word or sentence form being uttered by the user to execute a specific function of the image display apparatus 100 or perform an operation, the image display apparatus 100 may acquire the voice command and provide the acquired voice command in an audio data (or a voice signal) form to the voice recognition apparatus 120 via the communication network 110. The image display apparatus 100 may receive a recognition result for the voice command from the voice recognition apparatus 120 and perform the specific function or the operation based on the received recognition result. The phrase “execute the specific function or perform the operation” may mean that the image display apparatus 100 executes an application displayed in a screen or perform the operation such as channel switch and volume adjustment of the image display apparatus 100. During the process, the image display apparatus 100 may notify the user of execution of an application by popping-up a preset user interface (UI) window in a screen.

For example, in response to a word being uttered by the user, the image display apparatus 100 may perform an operation for executing a specific application. For example, in response to the word “Hi TV” being uttered by the user in a voice form, the image display apparatus 100 may perform an application corresponding to the uttered word. In response to a name of a sports star being mentioned, the image display apparatus 100 may execute an operation such as search for a current game of the star et cetera. A set-up operation of the user or the system designer may be accomplished in advance to perform a function or operation for the uttered specific word. Here, the voice command “Hi TV” uttered by the user may refer to a ‘trigger word’ in terms of an utterance start word for starting of the voice recognition.

In response to a voice utterance of a word being presented, the image display apparatus 100 may execute an internal fixed utterance engine in any degree without depending on the external voice recognition apparatus 120. For example, the image display apparatus 100 may autonomously generate a recognition result with respect to a voice command uttered by the user, determine whether or not the generated recognition result is presented in a preset command set, and perform an operation desired by the user, that is, an operation related to the voice command of the user in response to the recognition result being presented in the preset command set. However, this operation may be considerably restricted in the recent circumstances that contents such as broadcast, a movie, and music continue to emerge. Accordingly, a recognition engine of the voice recognition apparatus 120 having better performance than a recognition engine of the image display apparatus 100 may be used.

The image display apparatus 100 may generate different audio data with respect to the same voice command uttered by the user according to a location environment of the image display apparatus 100. For example, in response to “Hi TV” being uttered by the user in a distance of 1 m from the image display apparatus 100 and “Hi TV” being uttered by the user in a distance of 4 m from the image display apparatus 100, the image display apparatus 100 may differently recognize the same voice command according to whether the image display apparatus 100 is located in a quiet place such as home or in s public place such as a bus terminal. This is because the generated audio data types are different from each other.

Accordingly, the actual environment may be a factor which causes reduction in the recognition rate of the voice recognition apparatus 120. Even in response to the same voice command for operating the image display apparatus 100 being uttered by the user in an actual environment, the recognition performance is reduced and the recognition rate is reduced in the related art. That is, in the related art, even in response to the voice command being accurately uttered by the user, the image display apparatus 100 which may be located in various environments may often output a recognition result by determining the voice command as misrecognition.

However, in the exemplary embodiment, the recognition rate may be improved by determining the voice command, that is, the recognition result, which is determined as the misrecognition in the related art, as a normal recognition utterance using various voice commands directly collected through the image display apparatus 100 located in the actual environment. Here, the ‘normal recognition utterance’ may be an utterance of the voice command intentionally uttered by the user to operate the image display apparatus 100.

The image display apparatus 100 according to an embodiment may perform a log data collection operation to increase the performance rate. The log data collection operation may be performed, for example, for several days or several months in response to a DTV being firstly installed in a certain environment, but the log data collection operation may be periodically performed at a specific time every day. The log data collection operation may be slightly changed according to the actual environment that the image display apparatus 100 is located. For example, it may be assumed that the image display apparatus 100 is installed in a waiting room of a bus terminal. In this example, the log data collection operation may be performed only for a fixed period after the TV is installed. This is because the environment that the TV installed in the waiting room encounters may be daily repeated. An environment of a TV installed in home may also be daily repeated similarly to the TV installed in the waiting room, but the log data with respect to the TV in home may be periodically collected at fixed intervals after turn-on of the TV. However, in response to the TV is being turned on, but the user being not presented around the TV as an analysis result of an image imaged through a camera, the log data collection operation may not be performed. Since the various circumstances are likely to occur, how to collect the data may not be specially limited in the exemplary embodiment.

After the log data is collected, the image display apparatus 100 may provide the collected log data to the voice recognition apparatus 120. A log data providing method may be various. For example, the log data may be provided after in real time the log data collection is completed. In another example, the log data may be provided after at specific time intervals the log data collection is completed. The log data may include audio data for the voice command uttered by the user. For example, the image display apparatus 100 may provide all voices acquired through a microphone to the voice recognition apparatus 120. In another example, the image display apparatus 100 may extract a section determined as the voice command and provide only audio data in the extracted section to the voice recognition apparatus 120. In this example, the audio data in the extracted section may refer to a ‘section audio data’.

The communication network 110 may include both wired and wireless communication networks. The wired communication network may include an Internet network such as a cable network and a public switched telephone network (PSTN), and the wireless communication network may include code division multiple access (CDMA), wideband CDMA (WCDMA), global system for mobile communications (GSM), evolved packet core (EPC), long term evolution (LTE), a Wibro network, and the like. However, the communication network 110 in the exemplary embodiment is not limited thereto. The communication network 110 may be used, for example, in a clod computing network and the like under a cloud computing environment as a connection network of a next-generation mobile communication system to be implemented later. For example, in response to the communication network 110 being a wired communication network, an access point within the communication network 110 may be connected to a switching center of a telephone company and the like. In response to the communication network 110 being a wireless communication network, the access point within the communication network 110 may be connected to a serving general packet radio service (GPRS) support node (SGSN) or a gateway GPRS support node (GGSN) to process data or may be connected to various relays such as base station transmission (BTS), NodeB, and e⁻NodeB to process data.

The communication network 110 may include the access point. The access point may include a small base station such as a femto or pico base station mainly installed within a building. For example, the femto or pico base station may be divided according to the maximum number of image display apparatuses 100 connectable to the base station in terms of base station division. The access point may include a short-range communication module configured to perform short-range communication such as Zigbee and WiFi with the image display apparatus 100. The access point may use transmission control protocol/Internet protocol (TCP/IP) or real-time streaming protocol (RTSP) for wires communication. For example, the short-range communication may be performed with various standards such as Bluetooth, Zigbee, infrared data association (IrDA), radio frequency (RF) (for example, ultra high frequency (UHF) and very high frequency (VHF)), and ultra wideband (UWB) in addition to WiFi. In this example, the access point may extract a position of a data packet, designate an optimal communication path with respect to the extracted position, and transfer the data packet to next apparatus (for example, image display apparatus 100) along the designated communication path. The access pint may share multiple lines in a general network environment, and for example, the access point may include a router, a repeater, a relay, and the like.

The voice recognition apparatus 120 may include a server, and may serve as a kind of cloud server. For example, the voice recognition apparatus 120 may include all (or a portion of) hardware (HW) resources and software (SW) resources related to the voice recognition, and the voice recognition apparatus 120 may generate a recognition result with respect to the voice command received from the image display apparatus 100 having a minimum resource and provide the generated recognition result to the image display apparatus 100. However, the voice recognition apparatus 120 according to the exemplary embodiment is not limited to the cloud server. For example, in response to the communication network 110 being omitted in the voice recognition system and the direct communication being performed between the image display apparatus 100 and the voice recognition apparatus 120, the voice recognition apparatus 120 may be an external apparatus (that is, access point) or a peripheral apparatus such as a desktop computer. Any type of apparatus which may provide the recognition result with respect to a sound signal, that is, audio data provided from the image display apparatus 100 may be used as the voice recognition apparatus. Accordingly, the voice recognition apparatus 120 may be a recognition result providing apparatus.

The voice recognition apparatus 120 may include a fixed utterance engine. In an embodiment, the voice recognition apparatus 120 may perform an actual environment-reflected recognition operation through the fixed utterance engine. The voice recognition apparatus 120 may collect log data, to which audio data provided from the image display apparatus 100 used in the actual environment and a state of the image display apparatus 100 used in the actual environment (for example, audio data provided from a plurality of image display apparatuses 100 used in the actual environment and states of the plurality of image display apparatuses 100) are reflected, and build a recognition DB and a misrecognition DB using the collected log data. The voice recognition apparatus 120 may allow the recognition engine to learn using the build recognition DB. That is, the voice recognition apparatus 120 may update newly added information of the recognition DB to the recognition engine. The recognition engine may output a recognition result by performing the recognition operation with respect to the input recognition command based on the updated information.

For example, the voice recognition apparatus 120 according to an exemplary embodiment may receive the log data from the image display apparatus 100. The log data may include the audio data. The voice recognition apparatus 120 may divide the received log data into a recognition (recognized) sound source and a recognition (recognized) log and store the divided recognition sound source and recognition log. The voice recognition apparatus 120 may extract a voice section determined as a command uttered by the user from the received audio data or may store the log data by matching the previously extracted audio data as the recognition sound source with the recognition log. The voice recognition apparatus 120 may store the log data by classifying the log data according to time with respect to the same apparatus.

The voice recognition apparatus 120 may analyze the stored audio data, that is, the log data matching with the audio data determined as the voice section. That is, the voice recognition apparatus 120 may analyze the recognition log matching with the recognition sound source. For example, the voice recognition apparatus 120 may determine whether or not the voice command, for example, the trigger word is recognized in the log data read out from a memory. In response to the trigger word being recognized, the voice recognition apparatus 120 may further determine the log data related to the trigger word. In response to any utterance being not generated for a fixed time (for example, within a timeout) as the determination result or the image display apparatus 100 being directly terminated by the user, the recognition sound source determined as the trigger word may be classified into misrecognition data. The recognition result of the corresponding recognition sound source classified as the misrecognition data may be temporarily stored in the misrecognition DB. For example, this operation may refer to an operation of registering the recognition result in a misrecognition dictionary. In another example, this operation may refer to a primary filtering process with respect to the collected log data.

The recognition result with respect to the actual voice command for operating the image display apparatus 100 uttered by the user may be included in the recognition results which are primarily filtered and temporarily stored in the misrecognition DB. The voice recognition apparatus 120 may perform a verification process with respect to the recognition results classified as the misrecognition utterance. In the verification process, the voice recognition apparatus 120 may determine change in the recognition performance of the voice recognition apparatus 120 by adding the recognition results as the verification target to the recognition DB one by one. In response to the recognition rate being increased as the determination result, the corresponding recognition result may be added to the recognition DB. In response to the recognition rate for the corresponding recognition result being reduced, the recognition result may be kept in the misrecognition DB or deleted from the misrecognition DB. After all the recognition results are verified through the method, the voice recognition apparatus 120 may allow the recognition engine to learn the recognition result newly added to the recognition DB. That is, the data updating operation may be performed.

As compared with the voice recognition system which previously sets a recognition result determined as normal recognition and processes other recognition results as misrecognition in the related art, the voice recognition system may improve the misrecognition performance through the above-described configuration by accurately determining recognition results, which are variously recognized with respect to the voice commands uttered by the users in actual environments, as the normal recognition utterance.

It has been described that the voice recognition apparatus 120 is operated in connection with the image display apparatus 100. However, in an embodiment, the voice recognition apparatus 120 may be used in all apparatuses which support voice recognition, for example, all apparatuses such as a door system or a vehicle. In another example, the voice recognition apparatus 120 may be used in both an embedded recognizer and a server recognizer. In this example, the ‘embedded recognizer’ may refer to a voice recognizer which accomplishes the above-described voice recognition operation in a separate apparatus such as the image display apparatus 100 without connection with a server. In the exemplary embodiment, the apparatuses may collectively refer to a ‘user apparatus’.

In an embodiment, various home appliances such as a TV, a refrigerator, a washing machine, a settop box (STB), a media player, a tablet PC, a smart phone, and a PC have been sufficiently described with reference to the image display apparatus 100, but the home appliances may be operated as an individual apparatus configured to collect log data related to operation execution of an apparatus in an actual environment and transmit the collected log data to the voice recognition apparatus 120 of FIG. 1 or may perform the voice recognition operation using the collected log data through the voice recognizer embedded therein.

The processes may be selectively performed elastically according to a state of an apparatus used in the voice recognition, for example, presence/non-presence of a network and the like. For example, the voice recognition apparatus 120 may perform an operation which collects log data with respect to a plurality of image display apparatuses 100, search for a recognition result suitable for the actual environment, and update the recognition result. However, in response to a state of a network being unstable, the voice recognition apparatus 120 may perform the operation by variously changing the process, for example, by interrupting the log data collection operation of the image display apparatus 100 coupled to the corresponding network and the like.

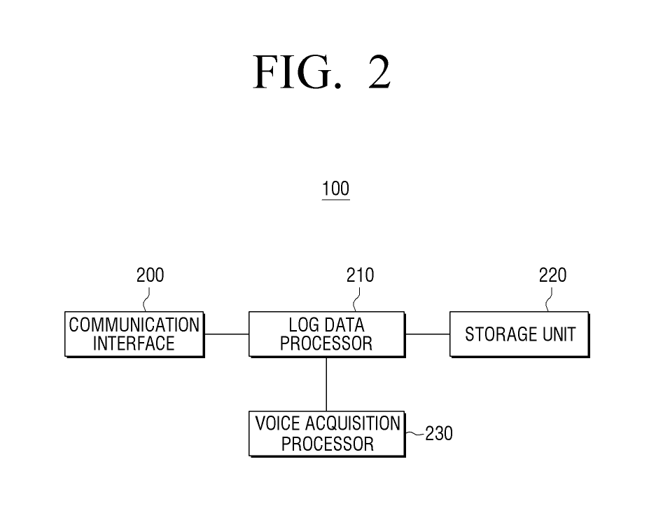

FIG. 2 is a block diagram illustrating a configuration of an image display apparatus according to a first exemplary embodiment. It may be assumed that the image display apparatus operates in connection with the voice recognition apparatus 120 of FIG. 1.

As illustrated in FIG. 2, the image display apparatus 100 according to the first exemplary embodiment may include all or a portion of a communication interface 200, a log data processor 210, e.g., a microprocessor, a storage unit 220, e.g., a memory, and a voice acquisition processor 230.

The phrase “include a part or all” may mean that the image display apparatus 100 may be configured in such a manner that a part of components such as the storage unit 200 and/or the voice acquisition processor 230 are omitted or a part of components such as the storage unit 220 is integrated into the log data processor 210. For a thorough understanding of the inventive concept, the image display apparatus 100 will be described to include all the components.

The communication interface 200 may perform communication with the voice recognition apparatus 120 via the communication network 110 of FIG. 1. In the exemplary embodiment, the communication interface 200 may transmit the log data stored in the storage unit 220 and audio data acquired in the voice acquisition processor 230 in response to the log data collection operation being performed in the image display apparatus 100 (or the log data being generated). The audio data may be included in the log data and transmitted. In an embodiment, this operation may correspond to the data building operation according to the log data collection. In response to the data building operation being completed, for example, the communication interface 200 may receive a recognition result with respect to a voice command of the user acquired through the voice acquisition processor 230 from the voice recognition apparatus 120 and transfer the received recognition result to the log data processor 210.

The log data processor 210 may be implemented with SW, and the log data processor 210 may perform a control function for the communication interface 200, the storage unit 220, and the voice acquisition processor 230 and may further perform an operation related to the log data collection. For example, in response to updating of the recognition result being requested by the user or in response to the image display apparatus 100 being shipped, the log data processor 210 may perform the log data collection operation according to the preset method. In this example, after the log data collection operation is performed in response to the image display apparatus 100 being firstly installed in a specific space, the log data collection operation may be periodically performed at fixed intervals. In another example, in response to a turn-on operation is performed according to application of power to the image display apparatus 100, the log data collection operation may be performed for a fixed time. For example, the image display apparatus 100 may store all data for a state in which the image display apparatus 100 is located and an operation which is performed by the image display apparatus 100 together with time information in the storage unit 220 through interfacing with the user from the turn-on timing. In this example, in response to the voice command uttered by the user being provided from the voice requisition unit 230, the voice command may also be stored in an audio data form. The image display apparatus 100 may store the audio data by extracting only a section corresponding to the voice command. The log data processor 210 may transmit the log data to the voice recognition apparatus 120 through the communication interface 200.

The log data processor 210 may be involved in the voice recognition operation. For example, in response to a voice being acquired through the voice acquisition processor 230, the audio data for the corresponding voice or only audio data in a specific section corresponding to the voice command may be provided to the voice recognition apparatus 120. The log data processor 210 may receive a recognition result with respect to the transmitted voice command and perform an operation according to the received recognition result. For example, operation information matching with the received recognition result may be stored in the storage unit 220, and the log data processor 210 may perform an operation requested by the user based on the corresponding operation information. As described above, in response to the operation information for executing a specific application being extracted, the log data processor 210 may execute the corresponding application. The operation information may be stored in a machine language recognizable in the image display apparatus 100, that is, a binary code form. Since the operation according to the recognition result is various, the application execution may be exemplified in the exemplary embodiment for clarity.

The storage unit 220 may store the log data provided from the log data processor 210. In response to a request of the log data processor 210 being presented, the storage unit 220 may output the stored log data. The log data may include a voice signal, that is, audio data for the voice command acquired through the voice acquisition processor 230 or may include the recognition result acquired by analyzing the audio data.

For example, the storage unit 220 may store the operation information matching with the recognition result provided from the voice recognition apparatus 120. In this example, the operation information may be stored in a binary code form as a machine language. For example, in response to a text-based recognition result with respect to the voice command of ‘Hi TV’ being ‘ha.i_t{.bi’, the binary code “1010” matching with the text-based recognition result may be output, and the log data processor 210 may determine the binary code to a command for executing an application of ‘Hi TV’ and execute the corresponding application.

The voice acquisition processor 230 may include a microphone and may acquire the voice command of the user through the microphone. For example, the voice acquisition processor 230 may acquire all voices in an actual environment in which the image display apparatus 100 is located. In this example, the voice may include various noises in addition to the voice command uttered by the user. In the exemplary embodiment, the voice other than the voice command uttered by the user may refer to the noise. Since the voice actually refers to a human voice, the voice including the noise may refer to a sound.

In an embodiment, the image display apparatus 100 may be configured in such a manner that the voice acquisition processor 230 is omitted. In the embodiment, the voice acquisition processor 230 which is independently configured from the image display apparatus 100 may be coupled to the communication 200 through a USB cable or a jack and perform the above-described operation. Accordingly, in the exemplary embodiment, the image display apparatus 100 is not limited to an image display apparatus which inevitably includes the voice acquisition processor 230.

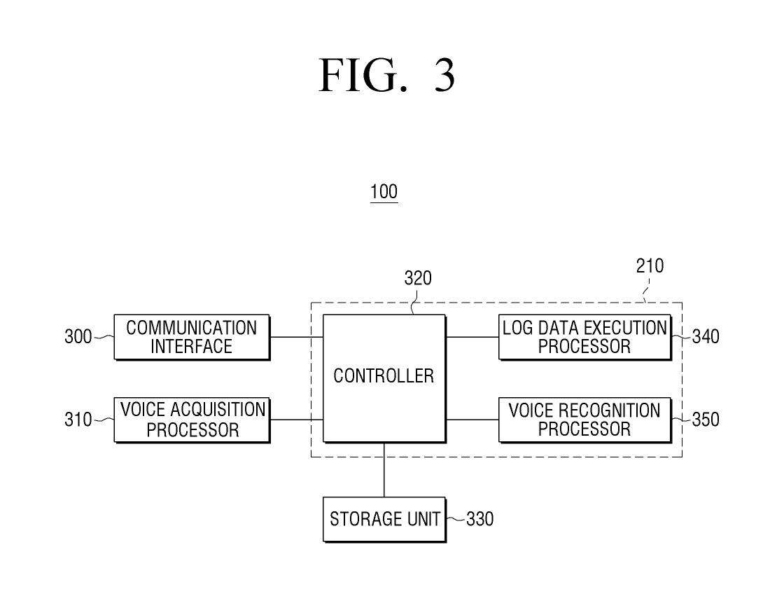

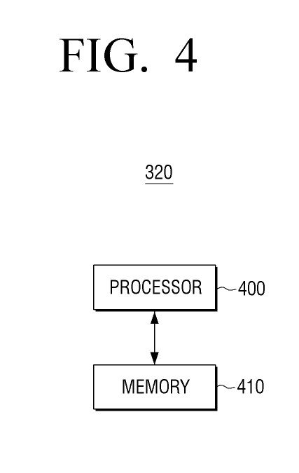

FIG. 3 is a block diagram illustrating a configuration of an image display apparatus according to a second exemplary embodiment, and FIG. 4 is a diagram illustrating a configuration of a controller of FIG. 3. It may be assumed in FIG. 4 that the controller has a combined structure of HW and SW.

As compared with the image display apparatus 100, an image display apparatus 100 in which the log data processor 210 of FIG. 2 is physically divided into a controller 320 and a log data execution processor 340 is illustrated in FIG. 3. The controller 320 may include a processor 400 such as a central processing unit (CPU) and a memory 410 as illustrated in FIG. 4. The memory 410 may be a volatile memory such as a random access memory (RAM).

The controller 320 may perform an overall control operation of all components in the image display apparatus 100. For example, in response to a command for collecting the log data from the user being provided, the controller 320 may control the log data execution processor 340 to execute the command. The log data execution processor 340 may execute the program related to log data processing according to a request of the controller 320.

For example, in the controller 320 having the configuration of FIG. 4 as illustrated in FIG. 3, the processor 400 of the controller 320 may load a program stored in the log data execution processor 340 and store the loaded program into the memory 410 in an initial operation of the image display apparatus 100. In response to the log data collection command being provided from the user, the controller 320 may execute the corresponding program loaded into the memory 410. In this example, the data processing speed may be faster than that in the image display apparatus 100 of FIG. 2.

The voice recognition processor 350 may not perform the whole operation of the voice recognition apparatus 120 described in FIG. 1 but may perform an operation for the voice recognition corresponding to a portion of the voice recognition operation in the voice recognition apparatus 120. Since the image display apparatus 100 according to the second exemplary embodiment is operated in connection with the voice recognition apparatus 120 of FIG. 1, the voice recognition processor 350 may perform the portion of the voice recognition operation in any degree. For example, the controller 320 may extract only a section, which is determined similar to the voice commands uttered by the users, other than noise from the audio data of the voice acquired through the voice acquisition processor 310 and provide the extracted section to the voice recognition apparatus 120. The voice recognition processor 350 of FIG. 3 may perform an operation of processing the audio data acquired by extracting only the section corresponding to the voice command.

Other than this point, the communication interface 300, the voice acquisition processor 310, the controller 320 and the log data execution processor 340, and the storage unit 330 of FIG. 3 are not significantly different from the communication interface 200, the log data processor 210, the storage unit 220, and the voice acquisition processor 230 of FIG. 2, and thus detailed description thereof will be omitted.

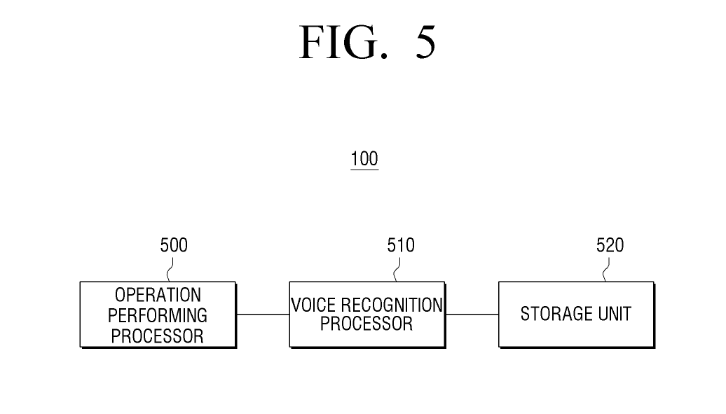

FIG. 5 is a block diagram illustrating a configuration of an image display apparatus according to a third exemplary embodiment and it may be assumed that an image display apparatus 100 may be a stand-alone type apparatus which independently performs the voice recognition operation from the voice recognition apparatus 120 of FIG. 1.

As illustrated in FIG. 5, the image display apparatus 100 according to the third exemplary embodiment may include all or a portion of an operation performing processor 500, a voice recognition processor 510, and a storage unit 520.

The phrase “include a part or all” may mean that the image display apparatus 100 may be configured in such a manner that a part of components such as the operation performing processor 500 is omitted or a part of components such as the storage unit 520 is integrated into the voice recognition processor 510. For a thorough understanding of the inventive concept, the image display apparatus 100 will be described to include all the components.

In an embodiment, the operation performing processor 500 may include all function blocks which may be operable by a voice command. For example, in response to ‘Hi TV’ being uttered by the user, the operation performing processor 500 may serve as a display so as to pop-up a UI screen under control of the voice recognition processor 510. In another example, in response to ‘Wi Fi’ being uttered by the user, the operation performing processor 500 may serve as a communication interface so as to perform communication with a peripheral access point.

In response to the log data collection operation being necessarily performed, the voice recognition processor 510 may generate log data with respect to a voice command provided from an external microphone and an operation state of the image display apparatus 100 and store the generated log data in the storage unit 520. The voice recognition processor 510 may determine whether or not the voice uttered by the user is a normal recognition utterance using the stored log data and use the recognition result determined as the normal recognition utterance in the voice recognition operation.

For example, the voice recognition processor 510 may include a fixed utterance engine. The voice recognition processor 510 may find a recognition result, which is unpredictable in an actual environment, using the log data acquired in the actual environment and allow the fixed utterance engine, that is, the recognition engine to learn the recognition result. That is, data for the recognition results may be updated.

The voice recognition processor 510 may improve the recognition performance and the misrecognition performance and provide the accurate feedback to the user by building the so-called ‘actual utterance DB’ collected in the actual environment and effectively using the actual utterance BD. For example, the voice recognition processor in the related art performs a function of performing the voice recognition and outputting a recognition result with respect to the recognition utterance in response to the similarity being exceeding a preset threshold value, but the voice recognition processor 510 in the exemplary embodiment may certainly determine the misrecognition and notify the user of the misrecognition in response to the recognition result being determined as the misrecognition.

In fact, since the voice recognition processor 510 has significant influence on the cost of the image display apparatus 100, the voice recognition processor 510 may be included not in the image display apparatus 100 but in the voice recognition apparatus 120 of FIG. 1 so as to include the Hi performance engine. However, the image recognition processor 510 may be included in the image display apparatus 100, and the image display apparatus 100 may include a recognition engine which has slightly lower performance than the recognition engine in the voice recognition apparatus 120. Accordingly, detailed description for the voice recognition processor 510 of FIG. 5 will be made in detail later.

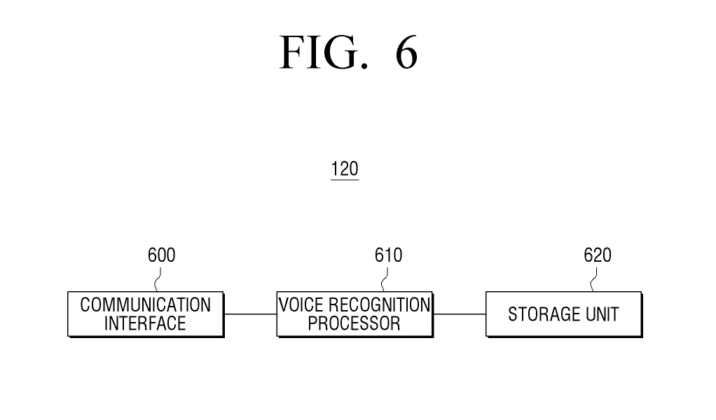

FIG. 6 is a block diagram illustrating a configuration of a voice recognition apparatus according to a first exemplary embodiment.

As illustrated in FIG. 6, the voice recognition apparatus 120 according to the first exemplary embodiment may include all or a portion of a communication interface 600, a voice recognition processor 610, and a storage unit 620. The phrase “include all or a part” may have the same meaning as that described in FIG. 2.

The communication interface 600 may perform communication with the image display apparatus 100 of FIG. 1. The communication interface 600 may receive log data provided from the image display apparatus 100 and transfer the received log data to the voice recognition processor 610. In this process, the voice recognition apparatus 120 may further perform an operation of restoring compressed data and the like.

In response to a voice command from the image display apparatus 100 being presented, the communication interface 600 may transfer a recognition result corresponding to the voice command to the image display apparatus 100 under control of the voice recognition processor 610.

The voice recognition processor 610 may largely perform two operations. First, the voice recognition processor 610 may collect the log data of the image display apparatus 100 operated in an actual environment in which the image display apparatus 100 is located so as to accurately recognize the voice command intentionally uttered by the user in the actual environment. The log data may also include audio data with respect to the voice command for operating the image display apparatus 100 by the user. For example, the voice recognition processor 610 may perform logging on various types of information recognized in the recognition engine, for example, an event such as turn-off of the image display apparatus 100 and a current state of an apparatus (for example, power saving, a network state, and the like) and store the logging result. The voice recognition processor 610 may store information with respect to a starting point of a voice in response to starting of voice recognition being detected in the recognition engine, an ending point of the voice in response to the voice being terminated, and a recognition result in the actual utterance DB. If necessary, the status information of an apparatus which currently uses the voice recognition may also be stored. All events and information may be stored together with the occurring timing. In this process, the voice recognition processor 610 may store the collected log data by classify the log data according to an apparatus or a time zone. The actual utterance DB may be the storage unit 620 of FIG. 6 or may be a separate DB.

The voice recognition processor 610 may read out the log data classified and stored in the actual utterance DB or the storage unit 620, refine the read log data to valuable data through the so-called ‘dictionary building unit’, and use the refined data in recognition/misrecognition dictionary learning. The dictionary building unit to be described later may build a dictionary using the log and the sound source transferred from the actual utterance DB. For example, in response to the voice command being determined through analysis of the log data, the voice recognition processor 610 may determine an event state subsequent to the determined voice command, that is, whether the event has any condition. The event state may refer to an operation state of the user apparatus. For example, a corresponding voice command for executing the ‘Hi TV’ application uttered by the user may be determined on the log data, and as a determination result of an event subsequent to the voice command, corresponding audio data may not be a normal recognition utterance intentionally uttered by the user. In this example, in response to no utterance being presented for a fixed time or the event being led to a termination operation of the image display apparatus 100, the voice recognition processor 610 may determine the corresponding audio data presumed as the voice command uttered by the user as misrecognition data and register the audio data in a misrecognition dictionary. In response to being determined that a normal utterance from the user subsequent to the audio data presumed as the voice command is presented, the voice recognition processor 610 may determine the corresponding audio data as the normal recognition data and register the audio data in the recognition dictionary.

In response to the primary filtering process being terminated, the voice recognition processor 610 may further perform verification on whether or not the filtered recognition result is properly accomplished. Accordingly, the voice recognition processor 610 may test how well be the corresponding recognition result recognized using audio experiment data (or experiment audio data) stored in the storage unit 620. For example, in response to the recognition result being registered in the recognition dictionary, but the recognition rate as the test result using the audio experiment data being reduced, the voice recognition processor 610 may determine the corresponding recognition result to be wrongly classified. In another example, in response to the recognition result being registered in the misrecognition dictionary, but the recognition as the test result using the audio experiment data being properly performed, the voice recognition processor 610 may allow the recognition engine to learn the corresponding recognition result for use in the actual environment. The voice recognition processor 610 may learn the recognition results finally verified through the above-described method. Accordingly, updating with respect to pre-stored recognition result and misrecognition result may be accomplished.

It has been described the example that the voice recognition processor 610 uses the audio experiment data, but this is not limited thereto in the exemplary embodiment. For example, other than the audio experiment data, the voice recognition processor 610 may update the primarily classified recognition data to the recognition engine one by one, apply the recognition rate to the actual environment based on the updated recognition data, and perform the performance test by deleting the corresponding updated recognition data or classifying the corresponding updated recognition data as misrecognition data again in response to the recognition rate being reduced.

For example, the storage unit 620 may be an actual utterance DB. In another example, the storage unit 620 may be a RAM or a read only memory (ROM) which is separately configured from the actual utterance DB. The storage unit 620 may store the audio experiment data required for the verification in addition to the log data. In response to the request of the voice recognition processor 610 being presented, the storage unit 620 may output the corresponding audio data. In response to the recognition being succeeded as the recognition performing result of the voice recognition processor 610, the storage unit 620 may store an uttered sound source by building a DB with respect to the uttered sound source. All data may be coded and stored in the storage unit 620.

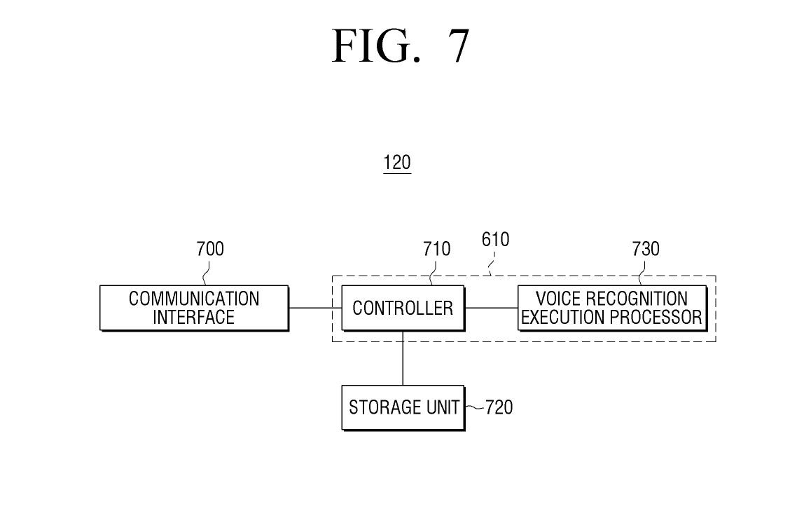

FIG. 7 is a block diagram illustrating a configuration of a voice recognition apparatus according to a second exemplary embodiment.

As illustrated in FIG. 7, a voice recognition apparatus 120 according to the second exemplary embodiment may include all or a portion of a communication interface 700, a controller 710, a storage unit 720, and a voice recognition execution processor 730. The phrase “include a part or all” may have the same meaning as that in FIG. 2.

As compared with the voice recognition apparatus 120 of FIG. 6, the voice recognition apparatus 120 in which the voice recognition processor 610 of FIG. 6 is physically divided into the controller 710 and the voice recognition execution processor 730 is illustrated in FIG. 7.

In response to a voice command being received from the image display apparatus 100, the controller 710 may execute the voice recognition execution processor 730 to acquire a recognition result and control the communication interface 700 to transmit the recognition result to the image display apparatus 100.

Like the controller 320 of FIG. 3, the controller 710 of FIG. 7 may have the same configuration as that in the FIG. 4. In response to the voice recognition apparatus 120″ starting to operation, the controller 710 may load a program stored in the voice recognition execution processor 730, store the program therein, and then use the stored program.

Other than this point, the communication interface 700, the controller 710 and the voice recognition execution processor 730, and the storage unit 720 of FIG. 7 are not significantly different from the communication interface 600, the voice recognition processor 610, and the storage unit 620 of FIG. 6, and thus detailed description thereof will be omitted.

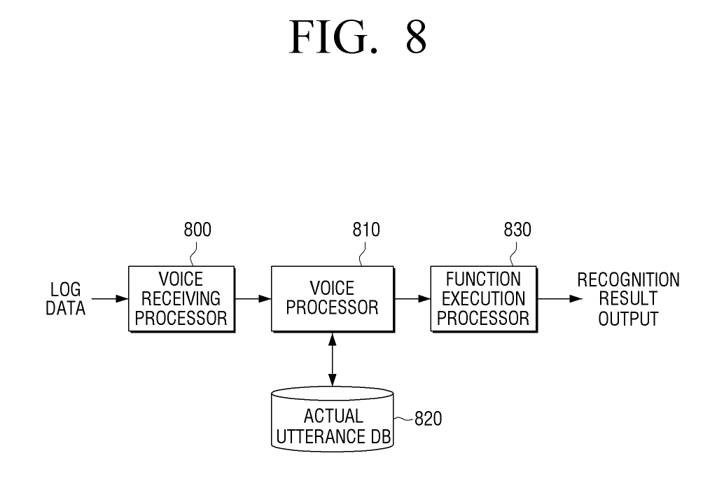

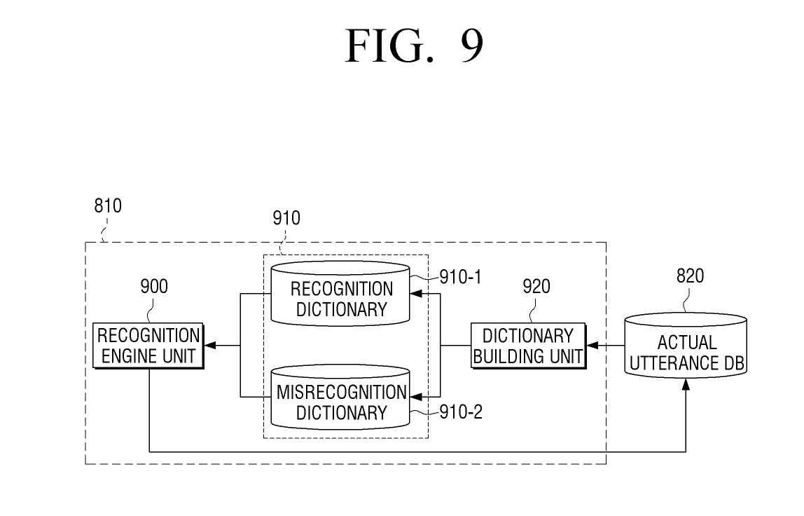

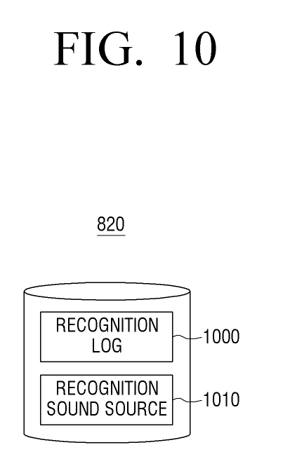

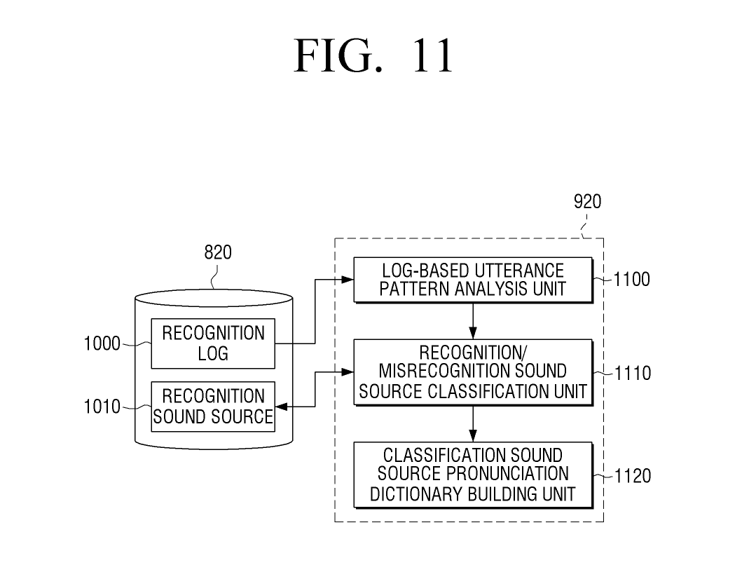

FIG. 8 is a detailed block diagram illustrating a configuration of the voice recognition processor of FIG. 6 or the voice recognition execution processor of FIG. 7, FIG. 9 is a detailed block diagram illustrating a configuration of a voice recognition unit of FIG. 8, and FIG. 10 is a diagram illustrating a structure of an actual utterance DB of FIG. 8. FIG. 11 is a detailed block diagram illustrating a configuration of a dictionary building unit of FIG. 10.

For clarity, referring to FIG. 8 with FIG. 7, the voice recognition execution processor 730 according to an exemplary embodiment may include all or a portion of a voice receiving processor (module) 800, a voice processor (module) 810, a function execution processor (module) 830, and an actual utterance DB 820.

In an embodiment, the term “unit” may refer to a configuration of HW, but the term “unit” may refer to a “module” in a SW configuration. The “module” of SW may be configured of HW, and thus the “unit” is not limited to SW or HW.

The phrase “include a part or all” may mean that the voice recognition execution processor 730 may be configured in such a manner that the actual utterance DB 820, the voice receiving processor 800 and/or the function execution processor 830 are omitted. For a thorough understanding of the inventive concept, the voice recognition execution processor 730 will be described to include all the components.

For example, the voice receiving processor 800 may receive log data provided from the communication interface 700. In this example, the voice receiving processor 800 may divide the received log data into a sound source corresponding to a voice command, that is, audio data and a log such as an event. In response to the log data being divided and provided in and from the communication interface 700, the voice receiving processor 800 may receive a divided type of data.

The voice processor 810 may divide the divided data into a recognition log 1000 and a recognition sound source 1010. For example, the voice processor 810 may divide audio data corresponding to the voice command or recognized similar to the voice command from status information such as the event and store the divided result in the actual utterance DB 820.

The voice processor 810 may analyze the recognition sound source 1010 and the recognition log 1000 stored in the actual utterance BD 820. For example, as illustrated in FIG. 9, the voice processor 810 may include a recognition engine unit 900, a recognition dictionary unit 910, and a dictionary building unit 920. The dictionary building unit 920 may include a log-based utterance pattern analysis unit 1100, a recognition/misrecognition sound source classification unit 1110, and a classification sound source pronunciation dictionary building unit 1120. According to the configuration (or classification), the voice processor 810 may perform a data refining job for learning of the recognition/misrecognition dictionary. For example, the log-based utterance pattern analysis unit (module) 1100 may determine whether log-based event and recognition result collected in various apparatuses, which use the corresponding system, are a normal utterance intended by the user or a misrecognition utterance unintended by the user. In response to an utterance starting word for starting of the voice recognition, that is, a trigger word being misrecognized, it may cause great inconvenience to the user. Accordingly, in the exemplary embodiment, the voice processor 810 may divide the recognition/misrecognition data using the log for the trigger recognition. The voice processor 810 may determine an utterance other than the trigger command on the basis of a similar criterion in any degree. In response to the determination being difficult, the voice processor 810 may perform separate marking processing on the corresponding data and sound source and then may not reflect the corresponding data and sound source to the recognition/misrecognition dictionary. The voice processor 810 may further perform verification on the corresponding data through the additional data verification module or may directly listen to the corresponding data and then progress information for data.

The dictionary building unit 920 will be described in detail with reference to FIG. 11. The log-based utterance pattern analysis unit 1100 may read out and analyze the recognition log 1000 and the recognition sound source 1010 which are divided and stored in the actual utterance DB 820 and determine whether or not the recognition sound source is a normal recognition utterance intended by the user by determining the log associated with the sound source. According to the determination result in the log-based utterance pattern analysis unit 1100, the recognition/misrecognition sound source classification unit 1110 may classify the recognition sound source 1010 into recognition/misrecognition sound sources and the classification sound source pronunciation dictionary building unit 1120 may build the recognition dictionary and the misrecognition dictionary with the classified sound sources.

For example, an example that the voice processor 810 which uses the trigger word to analyze the log for voice recognition starting is exemplified. The voice processor 810 may (1) extract the log generated in the same apparatus based on logs arranged according to time. The voice processor 810 may (2) determine (or confirm) whether or not the trigger word is recognized, (3) in response to any utterance being not generated within the timeout after the trigger word is recognized, (4) classify audio data presumed as the trigger word as misrecognition data by determining the audio data to triggering unintended by the user. The voice processor 810 may, (5) in response to a normal recognition utterance being generated after the trigger word is recognized, (6) classify the corresponding trigger word into normal recognition data. For example, in response to a TV being terminated by the user immediately after the trigger word is recognized, the voice processor 810 may (8) classify audio data corresponding to the corresponding trigger word into the misrecognition data (by determining this status to a status in which the user has no intention of trying the voice recognition).

The procedure for reflection in dictionary is performed on the divided data. As the determination result in the dictionary building unit 920, a recognition vocabulary may be temporarily stored in a recognition dictionary 910-1 and a misrecognition vocabulary may be temporarily stored in a misrecognition dictionary 910-2. The dictionary building unit 920 may determine the performance change using the recognition/misrecognition DB retained in the dictionary in response to a corresponding vocabulary being added to the dictionary. In response to the performance being improved, the dictionary building unit 920 may reflect the corresponding vocabulary to the dictionary and terminate the corresponding procedure. In response to the recognition performance being reduced to a reference value or less (for example, designated by the user) as compared with a value which is recognized using a DB in determining of the recognition/misrecognition performance, the dictionary building unit 920 may not reflect the corresponding vocabulary to the dictionary. Accordingly, the recognition performance may be guaranteed through the selective dictionary updating based on the refined DB and simultaneously the effect on the improvement in the misrecognition performance may be acquired.

Table 1 shows a recognition result which is performed after all dictionaries, which are classified into the misrecognition with respect to the trigger word ‘Hi TV’, are registered without verification.

TABLE 1

| | | | | Recording distance | |
|---|---|---|---|---|---|
| | Registration | Registration | Registration | (each 100) | |
| Classification | dictionary | vocabulary | pronunciation | 1 m | 4 m |
| Existing | Recognition | Hi TV | ha.i_t{i.bi | 98 | 97 |
| | dictionary | Hi TV | h60.i_t{i.bi | 2 | 2 |
| | registration | | | | |
| Wrong | Recognition | Hi TV | ha.i_t{i.bi | 97 | 88 |
| misrecognition | dictionary | Hi TV | h60.i_t{i.bi | 1 | 1 |
| dictionary | registration | | | | |
| registration | Misrecognition | I P | a.i_p{i.i | 0 | 0 |
| | dictionary | I P | a.i_pi | 0 | 0 |
| | registration | Hi kick | ha.i.k{ik | 0 | 2 |
| | | I P | a.i_t{i.bi | 2 | 5 |
| | | A TV | e.i_t{i.bi | 0 | 0 |
| | | Hi team | ha.i.t{im | 0 | 1 |
| | | I T | a.i_t{i | 0 | 2 |

(Performing recognition after 100 ‘Hi TV’ sound sources are recorded in distances of 1 m to 4 m)

As shown in Table 1, in a state that two sound sources are registered in the existing recognition dictionary and no sound source is registered in the misrecognition dictionary, 100 sound sources among the 100 sound sources succeed in the recognition in response to the sound sources being recorded in the distance of 1 m, and 99 sound sources among the 100 sound sources succeed in the recognition in response to the sound sources are recorded in the distance of 4 m.

However, in response to the recognition being performed using the same sound sources after the misrecognition dictionary is updated without verification, 98 sound sources and 89 sound sources among the 100 sound sources succeed in the recognition. Due the registration of the very significantly similar utterance such as “I TV”, the recognition rate is considerably reduced with respect to the recording distance of 4 m, but the performance for the misrecognition is improved.

As shown in Table 2, in the existing recognition, the misrecognition is generated 4 times up to TH2, and the misrecognition is generated once even in TH3. However, after the misrecognition dictionary registration, the misrecognition is generated once in TH2, and no misrecognition is generated in TH3.

TABLE 2

| | | | | Misrecognition distribution | | | |
|---|---|---|---|---|---|---|---|
| | Registration | Registration | Registration | for threshold (TH) | | | |
| | dictionary | vocabulary | pronunciation | TH1 | TH2 | TH3 | TH4 |
| Existing | Recognition | Hi TV | ha.i_t{i.bi | 266 | 1 | 0 | 0 |
| | dictionary | Hi TV | h60.i_t{i.bi | 1498 | 3 | 1 | 0 |
| | registration | | | | | | |
| | | | Total | 1764 | 4 | 1 | 0 |
| Wrong | Recognition | Current | ha.i_t{i.bi | 1 | 0 | 0 | 0 |
| misrecognition | dictionary | pronunciation | | | | | |
| dictionary | registration | Current | h60.i_t{i.bi | 135 | 1 | 0 | 0 |
| registration | | pronunciation | | | | | |
| | Misrecognition | I P | a.i_p{i.i | 12 | 0 | 0 | 0 |
| | dictionary | I P | a.i_pi | 286 | 3 | 1 | 1 |
| | registration | Hi kick | ha.i.k{ik | 272 | 1 | 1 | 0 |
| | | I P | a.i_t{i.bi | 0 | 0 | 0 | 0 |
| | | A TV | e.i_t{i.bi | 58 | 1 | 0 | 0 |
| | | Hi team | ha.i.t{im | 592 | 5 | 1 | 0 |
| | | I T | a.i_t{i | 247 | 0 | 0 | 0 |
| | | | Total | 1603 | 11 | 3 | 1 |

(Misrecognition Result in Two Hour-Broadcast Content Recognition)

As shown in Table 2, the misrecognition may be prevented through minimum recognition performance reduction in response to the recognition/misrecognition performance verification operation proposed in the exemplary embodiment being performed in a state that the misrecognition performance is improved, but the recognition performance is reduced.

As shown in Table 3, in response to two misrecognition dictionaries being additionally updated after “I TV” is removed, as compared with the recognition rate before the verification, the recognition rate is improved from 98% to 100% with respect to the recognition in the recording distance of 1 m, and the recognition rate is improved from 89% to 94% with respect to the recognition in the recording distance of 4 m.

TABLE 3

| | | | | Recording distance | |
|---|---|---|---|---|---|
| | Registration | Registration | Registration | (each 100) | |
| Classification | dictionary | vocabulary | pronunciation | 1 m | 4 m |
| Existing | Recognition | Hi TV | ha.i_t{i.bi | 98 | 97 |
| | dictionary | Hi TV | h60.i_t{i.bi | 2 | 2 |
| | registration | | | | |
| Wrong | Recognition | Hi TV | ha.i_t{i.bi | 98 | 93 |
| misrecognition | dictionary | Hi TV | h60.i_t{i.bi | 2 | 1 |
| dictionary | registration | | | | |
| registration | Misrecognition | I P | a.i_p{i.i | 0 | 0 |
| | dictionary | I P | a.i_pi | 0 | 0 |
| | registration | Hi kick | ha.i.k{ik | 0 | 2 |
| | | A TV | e.i_t{i.bi | 0 | 0 |
| | | Hi team | ha.i.t{im | 0 | 1 |
| | | I T | a.i_t{i | 0 | 2 |
| | | I O T | a.i_o_t{i | 0 | 0 |
| | | IOT | a.i.o.t{i | 0 | 0 |

It can be seen from the recognition result in Table 4 that the number of misrecognition times is kept to zero (0) in TH3.

TABLE 4

| | | | | Misrecognition | | | |
|---|---|---|---|---|---|---|---|
| | | | | distribution for | | | |
| | Registration | Registration | Registration | threshold (TH) | | | |
| | dictionary | vocabulary | pronunciation | TH1 | TH2 | TH3 | TH4 |
| Existing | Recognition | Current | ha.i_t{i.bi | 1 | 0 | 0 | 0 |
| | dictionary | pronunciation | | | | | |
| | registration | Current | h60.i_t{i.bi | 135 | 1 | 0 | 0 |
| | | pronunciation | | | | | |
| Wrong | Misrecognition | IP | a.i_t{i.i | 12 | 0 | 0 | 0 |
| misrecognition | dictionary | IP | a.i_pi | 234 | 3 | 1 | 1 |
| dictionary | registration | Hi kick | ha.i_k{ik | 253 | 1 | 1 | 1 |
| registration | | A TV | e.i_t{i.bi | 55 | 2 | 1 | 1 |
| | | Hi team | ha.i.t{im | 487 | 5 | 1 | 1 |
| | | I T | a.i_t{i | 285 | 0 | 0 | 0 |
| | | I O T | a.i_o_t{i | 52 | 0 | 0 | 0 |
| | | I O T | a.i.o.t{i | 126 | 0 | 0 | 0 |
| | | | Total | 1612 | 12 | 4 | 4 |

As described above, the voice processor 810, for example, the recognition engine unit 900 may finally determine whether or not the recognition results are used in the voice recognition by performing verification on the recognition results which are primarily classified into the normal recognition data and the misrecognition data. Referring to FIG. 9, the recognition engine unit 900 of the voice processor 810 may be updated with the finally determined recognition result, and then the voice processor 810 may use the updated recognition result in the voice recognition.

The actual utterance DB 820 may perform logging on various information and events recognized in the recognition engine of the voice processor 810 and a current state of an apparatus and store the logging result. The actual utterance DB 820 may store uttered sound source by building a DB with respect to the uttered sound source in the recognition success. The actual utterance DB 820 may store data by coding all the data.

The function execution processor 830 may output the recognition result generated in the voice processor 810. For example, the function execution processor 830 may further determine whether or not the recognition result exceeds a preset threshold value and output the recognition result with respect to the utterance recognized in exceeding the preset threshold value.

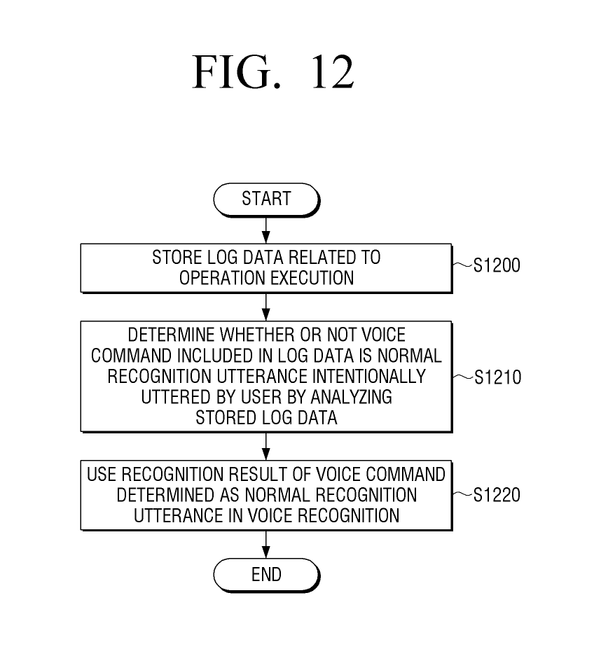

FIG. 12 is a diagram illustrating a driving process of an image display apparatus according to an exemplary embodiment.

For clarity, referring to FIG. 12 with FIG. 1, the image display apparatus 100 according to an exemplary embodiment may independently operate without connection with the voice recognition apparatus 120 in response to a fixed utterance engine configured to perform a voice recognition function being included in the image display apparatus 100.

The image display apparatus 100 may store a current state of an apparatus and log data related to operation execution of the apparatus (S1200). For example, after the user utters a voice command, all the information for termination of the image display apparatus 100 and the like may be stored.

The image display apparatus 100 may perform a recognition data building operation to be used in the voice recognition by analyzing the stored log data.

For example, the image display apparatus 100 may determine whether or not the voice command included in the log data is a normal recognition utterance intentionally uttered by the user by analyzing the stored log data. In this example, in response to a termination state being determined after the voice command as described above, the corresponding voice command may be determined as an utterance unintentionally uttered by the user and classified into misrecognition data.

However, in response to being determined that a normal utterance is further presented after the trigger word such as ‘Hi TV’ is uttered as the voice command, the image display apparatus may classify the recognition result of the voice command as the corresponding trigger word into the recognition data.

In the process, the image display apparatus 100 may further perform a verification operation for determining whether or not the recognition result is properly classified using the recognition result classified into the recognition data and the misrecognition data. The verification operation has been significantly described in advance, and detailed description thereof will be omitted.

In response to the verification operation being completed, the image display apparatus 100 may use the recognition result of the voice command determined as the normal recognition utterance in the voice recognition (S1220).

For clarity, the example that the image display apparatus 100 may simultaneously perform the log data collection operation and the voice recognition operation has been described in FIG. 12. However, the example may be implemented in various apparatuses such as a refrigerator, a washing machine, a settop box, and a media player (for example, audio apparatus) in addition to the image display apparatus 100 such as a TV, a tablet PC, a smart phone, a desktop PC, and a laptop PC.

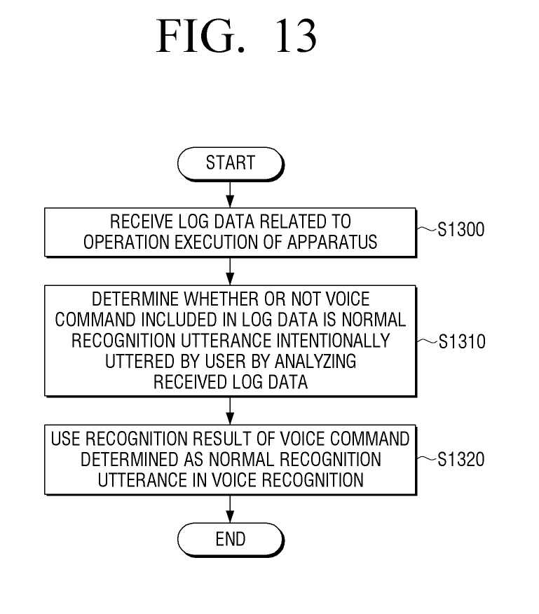

FIG. 13 is a flowchart illustrating a driving process of a voice recognition apparatus according to a first exemplary embodiment.

As compared with the driving process of FIG. 12, the driving process of FIG. 13 is different from the driving process of FIG. 12 in that since the processing target of the voice recognition is the voice recognition apparatus 120 of FIG. 1, the voice recognition apparatus 120 may receive log data provided from the image display apparatus 100 (S1300) and use the received log data.

The image display apparatus 100 may include a refrigerator, a washing machine, a settop box, and a media player (for example, audio apparatus) as described above. Accordingly, the apparatuses may operate as an individual apparatus which collects the log data in an actual environment, and may transfer the collected log data to the voice recognition apparatus 120.

The driving method of FIG. 13 is not significantly different from the driving method of FIG. 12 other than the difference, and detailed description thereof will be omitted.

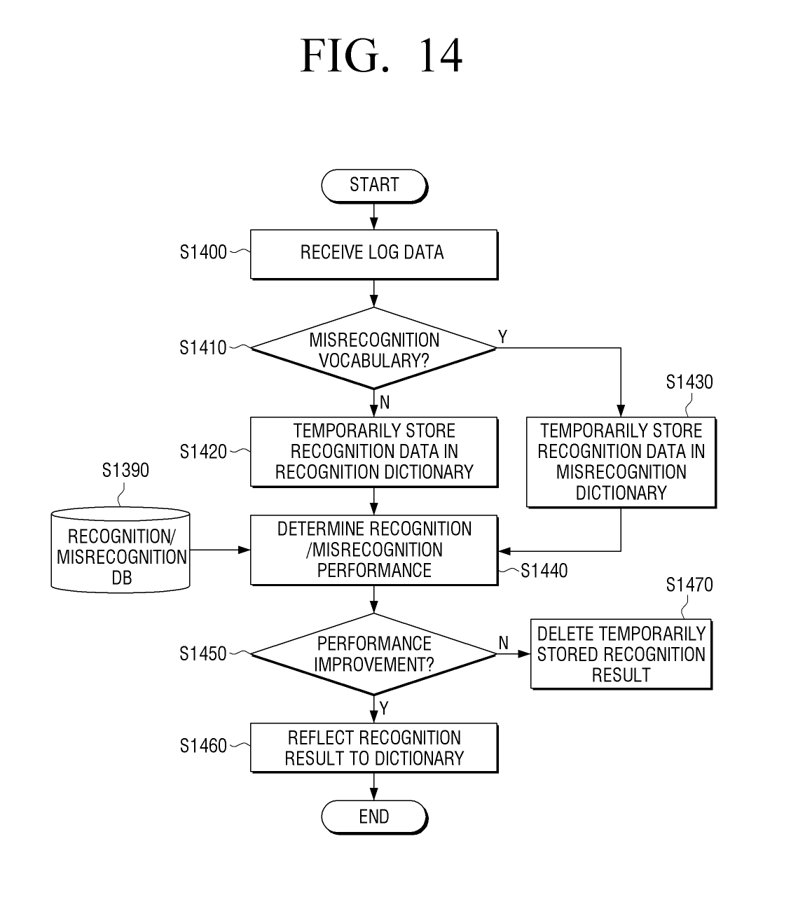

FIG. 14 is a flowchart illustrating a driving method of a voice recognition apparatus according to a second exemplary embodiment.

For clarity, referring to FIG. 14 with FIG. 1, for example, the voice recognition apparatus 120 according to an exemplary embodiment may receive log data from the image display apparatus 100 (S1400). The received log data may include a voice command presumed as a trigger word.

The voice recognition apparatus 120 may determine whether or not the presumed voice command is a misrecognition vocabulary by analyzing the log data (S1410). The determination operation has been described in FIG. 12 in advance, and thus detailed description thereof will be omitted.

The voice recognition apparatus 120 may temporarily store the corresponding recognition data in the misrecognition dictionary in response to the voice command being determined as a misrecognition vocabulary as the determination result and may temporarily store the corresponding recognition data in the recognition dictionary in response to the voice command being not determined as the misrecognition vocabulary as the determination result (S1420 and S1430).

The voice recognition apparatus 120 may determine recognition/misrecognition performance indicating whether the pieces of temporarily stored recognition data are properly classified using the corresponding recognition data (S1440).

The voice recognition apparatus 120 may register the pieces of corresponding recognition data in the existing registered recognition/misrecognition DB and use the registered recognition data (S1390). In this operation, the voice recognition apparatus may further use a plurality of pieces of audio experiment data.

For example, the voice recognition apparatus 120 may determine whether or not the plurality of pieces of audio experiment data are properly recognized as the existing recognition result registered in the recognition/misrecognition DB and the additionally registered recognition result (S1440).

For example, the voice recognition apparatus 120 may register the corresponding recognition result in the recognition dictionary in response to the performance being improved as the determination result, that is, the recognition rate being increased (S1450 and S1460). The data of recognition result may be updated by registering the corresponding recognition result in the recognition dictionary.

In response to the performance being not improved, the voice recognition apparatus 120 may delete the temporarily stored data or manage the temporarily stored data as the misrecognition DB (S1470).

It has been described that all the components constituting the exemplary embodiment are combined into one or operated in the combined form into one, but this is not necessarily limited thereto. For example, within the purpose scope of the inventive concept, one or more of the components may be selectively coupled and operated. All the components are implemented with pieces of hardware independent from each other, but the part or all of the components may be selectively combined and implemented with a computer program having a program module which performs a part or all of functions combined in one or a plurality of pieces of hardware. Codes and code segments constituting the computer program may be readily deduced by those who skilled in the art. The exemplary embodiment may be implemented in such a manner that the computer program may be stored in a non-transitory computer readable medium and read and executed by the computer.

The non-transitory computer-recordable medium is not a medium configured to temporarily store data such as a register, a cache, or a memory but an apparatus-readable medium configured to permanently or semi-permanently store data. For example, the above-described various programs may be stored in the non-transitory apparatus-readable medium such as a compact disc (CD), a digital versatile disc (DVD), a hard disc, a Blu-ray disc, a universal serial bus (USB), a memory card, or a read only memory (ROM), and provided.

Although a few exemplary embodiments have been shown and described, exemplary embodiments are not limited thereto. It would be appreciated by those skilled in the art that changes may be made in these exemplary embodiments without departing from the principles and spirit of the disclosure, the scope of which is defined in the claims and their equivalents.

What is claimed is:

1. A voice recognition apparatus comprising:
a voice recognition microprocessor configured to analyze log data related to operation execution of the voice recognition apparatus, determine whether or not a voice command included in the log data is a normal recognition utterance, which has been intentionally uttered by a user to operate the voice recognition apparatus, based on a result of an analysis, and build a recognition result of the voice command, which is determined as the normal recognition utterance, as a determination result in a database (DB).

2. The voice recognition apparatus as claimed in claim 1, wherein the voice recognition microprocessor is configured to confirm whether the voice command is included in the log data, and determine whether the voice command is the normal recognition utterance by confirming an operation state of the voice recognition apparatus subsequent to the voice command being confirmed based on the log data.

3. The voice recognition apparatus as claimed in claim 2, wherein the voice recognition microprocessor is configured to determine the voice command as the normal recognition utterance, in response to another voice command uttered subsequent to the voice command being confirmed by the operation state.

4. The voice recognition apparatus as claimed in claim 2, wherein the voice recognition microprocessor is configured to determine the voice command as a misrecognition utterance, which has been unintentionally uttered by the user, in response to an absence of a user utterance subsequent to the voice command within a certain time or a power to the voice recognition apparatus being turned off as the operation state.

5. The voice recognition apparatus as claimed in claim 2, wherein the voice recognition microprocessor is configured to temporarily store the recognition result determined as the normal recognition utterance, and a recognition result determined as a misrecognition utterance, which has been unintentionally uttered by the user, and verify whether or not a recognition rate is improved by the temporarily stored recognition results by checking whether or not preset audio experiment data is recognized as the temporarily stored recognition results.

6. The voice recognition apparatus as claimed in claim 2, wherein the voice recognition microprocessor is configured to temporarily store the recognition result determined, as the normal recognition utterance, and a recognition result determined, as a misrecognition utterance, which has been unintentionally uttered by the user, and verify whether or not a recognition rate is improved by the temporarily stored recognition results by determining whether or not the received voice command is recognized as the temporarily stored recognition results.

7. The voice recognition apparatus as claimed in claim 5, wherein the voice recognition microprocessor is configured to build the recognition result of which the recognition rate is improved as a verification result in the DB.

8. The voice recognition apparatus as claimed in claim 1, further comprising:
a communication interface configured to transmit the log data to a server-based voice recognition apparatus to build the recognition result in the DB of the server-based voice recognition apparatus.

9. The voice recognition apparatus as claimed in claim 8, wherein the communication interface is configured to transmit the log data as a text-based recognition result acquired by analyzing audio data of the voice command.

10. A method of driving a voice recognition apparatus, the method comprising:
analyzing log data related to operation execution of the voice recognition apparatus;
determining whether or not a voice command included in the log data is a normal recognition utterance, which has been intentionally uttered by a user to operate the the voice recognition apparatus, based on a result of the analyzing; and
building a recognition result of the voice command determined, as the normal recognition utterance, as a determination result in a database (DB).

11. The method as claimed in claim 10, wherein the determining includes:
confirming the normal recognition utterance by confirming whether the voice command is included in the log data, and by confirming an operation state of the voice recognition apparatus subsequent to the voice command being confirmed based on the log data.

12. The method as claimed in claim 11, wherein the determining includes:
determining the voice command as the normal recognition utterance, in response to another voice command uttered subsequent to the voice command being confirmed by the operation state.

13. The method as claimed in claim 11, wherein the determining includes:
determining the voice command as a misrecognition utterance, which has been unintentionally uttered by the user, in response to an absence of a user utterance subsequent to the voice command within a certain time or a power of the voice recognition apparatus being turned off as the operation state.

14. The method as claimed in claim 11, further comprising:
storing preset audio experiment data;
temporarily storing the recognition result determined as the normal recognition utterance and a recognition result determined as a misrecognition utterance unintentionally uttered by the user; and
verifying whether or not a recognition rate is improved by the temporarily stored recognition results by checking whether or not the preset audio experiment data is recognized as the temporarily stored recognition results.

15. The method as claimed in claim 11, further comprising:
temporarily storing the recognition result determined as the normal recognition utterance and a recognition result determined as a misrecognition utterance unintentionally uttered by the user; and
verifying whether or not a recognition rate is improved by the temporarily stored recognition results by determining whether or not the received voice command is recognized as the temporarily stored recognition results.

16. The method as claimed in claim 15, wherein the building the DB includes:
building the DB with respect to the recognition result of which the recognition rate is improved as a verification result.

17. The method as claimed in claim 10, further comprising:
transmitting the log data to a server-based voice recognition apparatus to build the DB with respect to the recognition result in the server-based voice recognition apparatus.

18. The method as claimed in claim 17, wherein the transmitting includes:
transmitting the log data as a text-based recognition result acquired by analyzing audio data of the voice command.

19. A non-transitory computer-readable recording medium including a program for executing a method of driving a voice recognition apparatus, the method comprising:
analyzing log data related to operation execution of the voice recognition apparatus;
determining whether or not a voice command included in the log data is a normal recognition utterance, which has been intentionally uttered by a user to operate the the voice recognition apparatus, based on a result of the analyzing; and
building a recognition result of the voice command determined as the normal recognition utterance as a determination result in a database (DB).
